(19) United States
(12) Patent Application Publication
(10) Pub. No.: US 2024/0273188 A1
(43) Pub. Date: Aug. 15, 2024

(54) DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS

(71) Applicant: BlueVoyant LLC, New York, NY (US)

(72) Inventors: Dorian Birsan, Ontario (CA); Marius Mocanu, Ontario (CA); Adrian Grigorof, Ontario (CA); Igor Bologan, Bucharest (RO); Catalin Duta, Bucharest (RO)

(73) Assignee: BlueVoyant LLC, New York, NY (US)

(21) Appl. No.: 18/563,484

(22) PCT Filed: Jun. 3, 2022
(86) PCT No.: PCT/US2022/072739

§ 371 Date: Nov. 22, 2023

Related U.S. Application Data
(60) Provisional application No. 63/196,458, filed on Jun. 3, 2021.

(51) Int. Cl. G06F 21/55

(52) U.S. Cl. CPC G06F 21/552

(57) ABSTRACT

A method for enhancing network security across a plurality of tenants configured to host a plurality of client applications is disclosed herein. The method includes: providing a SIEM management application hosted by a SIEM provider server communicably coupled to the plurality of tenants; receiving a SIEM status from the plurality of tenants; visualizing the SIEM status; filtering the SIEM status based on a user input received via the graphical user interface; visualizing the filtered SIEM status; selecting, via the graphical user interface, at least one client application of the plurality of clients applications hosted by at least one tenant of the plurality of tenants to update based on the filtered SIEM status; generating a client application update, and an update alert based on the selection; transmitting the update alert to the at least one tenant; and updating the at least one client application based on the update alert.

### CROSS-REFERENCE TO RELATED APPLICATIONS

This application claims the benefit of priority under 35 U.S.C. § 119(e) to U.S. Provisional Patent Application Ser. No. 63/196,458, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed Jun. 3, 2021, the disclosure of which is herein incorporated by reference in its entirety.

### FIELD

The present disclosure is generally related to network security, and, more particularly, is directed to improved devices, systems, and methods for issuing Security Information, and Event Management (SIEM) client updates.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a method for enhancing network security across a plurality of tenants configured to host a plurality of client applications is disclosed. The method includes: providing a SIEM management application hosted by a SIEM provider server communicably coupled to the plurality of tenants; receiving a SIEM status from the plurality of tenants; visualizing the SIEM status; filtering the SIEM status based on a user input received via the graphical user interface; visualizing the filtered SIEM status; selecting, via the graphical user interface, at least one client application of the plurality of clients applications hosted by at least one tenant of the plurality of tenants to update based on the filtered SIEM status; generating a client application update, and an update alert based on the selection; transmitting the update alert to the at least one tenant; and updating the at least one client application based on the update alert.

In various aspects, a system for enhancing network security is disclosed. The system can include: a plurality of tenants configured to host a plurality of clients; and a Security Information, and Event Management (SIEM) provider server communicably coupled to the plurality of tenants, wherein the SIEM provider server includes a processor, and a memory, wherein the memory is configured to store a SIEM management application that, when executed by the processor, causes the processor to: receive a SIEM status from the plurality of tenants; visualize the SIEM status via a graphical user interface of the SIEM management application illustrated on a display communicably coupled to the SIEM provider server; filter the SIEM status based, at least in part, on a user input received via the graphical user interface; visualize the filtered SIEM status via the graphical user interface; determine at least one client of the plurality of clients hosted by at least one tenant of the plurality of tenants to update based, at least in part, on the filtered SIEM status; generate an update alert based, at least in part, on the determination; transmit the update alert to the at least one tenant; and update the at least one client application based, at least in part, on the update alert, wherein updating the at least one client enhances the network security for the at least one tenant.

These, and other objects, features, and characteristics of the present invention, as well as the methods of operation, and functions of the related elements of structure, and the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration, and description only, and are not intended as a definition of the limits of the invention.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

FIG. 1 illustrates a diagram of a system configured to enhance Security Information, and Event Management (SIEM) updates, in accordance with at least one non-limiting aspect of the present disclosure;

FIG. 2 illustrates a deployment diagram of the system of FIG. 1, including a SIEM management application, in accordance with at least one non-limiting aspect of the present disclosure;

FIG. 3 illustrates a graphical user interface of the SIEM management application of FIG. 2, in accordance with at least one non-limiting aspect of the present disclosure;

FIG. 4 illustrates another graphical user interface of the SIEM management application of FIG. 2, in accordance with at least one non-limiting aspect of the present disclosure;

FIG. 5 illustrates another graphical user interface of the SIEM management application of FIG. 2, in accordance with at least one non-limiting aspect of the present disclosure;

FIG. 6 illustrates another graphical user interface of the SIEM management application of FIG. 2, in accordance with at least one non-limiting aspect of the present disclosure;

FIG. 7 illustrates another graphical user interface of the SIEM management application of FIG. 2, in accordance with at least one non-limiting aspect of the present disclosure;

FIG. 8 illustrates another graphical user interface of the SIEM management application of FIG. 2, in accordance with at least one non-limiting aspect of the present disclosure;

FIG. 9 illustrates another graphical user interface of the SIEM management application of FIG. 2, in accordance with at least one non-limiting aspect of the present disclosure;

FIG. 10 illustrates another graphical user interface of the SIEM management application of FIG. 2, in accordance with at least one non-limiting aspect of the present disclosure;

FIG. 11 illustrates a method of using the system of FIG. 1, and the SIEM management application of FIG. 2, in accordance with at least one non-limiting aspect of the present disclosure; and

FIG. 12 illustrates another graphical user interface of the SIEM management application of FIG. 2, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

The Applicant of the present application owns the following U.S. Provisional Patent Applications, the disclosure of each of which is herein incorporated by reference in its entirety:
U.S. Provisional Patent Application No. 63/196,991, titled DEVICES, SYSTEMS, AND METHODS FOR STANDARDIZING & STREAMLINING THE DEPLOYMENT OF SECURITY INFORMATION & EVENT MANAGEMENT ARTIFACTS FOR MULTIPLE TENANTS, filed on Jun. 4, 2021;
U.S. Provisional Patent Application No. 63/294,570 titled DEVICES, SYSTEMS, AND METHODS FOR PROVISIONING AND UPDATING SECURITY INFORMATION & EVENT MANAGEMENT ARTIFACTS FOR MULTIPLE TENANTS, filed on Dec. 29, 2021;
U.S. Provisional Patent Application No. 63/295,150 titled DEVICES, SYSTEMS, AND METHODS FOR STREAMLINING AND STANDARDIZING THE INGEST OF SECURITY DATA ACROSS MULTIPLE TENANTS, filed on Dec. 30, 2021;
U.S. Provisional Patent Application No. 63/302,828 titled DEVICES, SYSTEMS, AND METHODS FOR REMOTELY MANAGING ANOTHER ORGANIZATION'S SECURITY ORCHESTRATION, AUTOMATION, AND RESPONSE, filed on Jan. 25, 2022;
U.S. Provisional Patent Application No. 63/313,422 titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 24, 2022;
U.S. Provisional Patent Application No. 63/341,264 titled DEVICES, SYSTEMS, AND METHODS FOR SUMMARIZING ANALYTIC OBSERVATIONS, filed on May 12, 2022;
U.S. Provisional Patent Application No. 63/344,305 titled DEVICES, SYSTEMS, AND METHODS FOR INGESTING & ENRICHING SECURITY INFORMATION TO AUTONOMOUSLY SECURE A PLURALITY OF TENANT NETWORKS, filed on May 20, 2022; and
U.S. Provisional Patent Application No. 63/345,679 titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 25, 2022.

Numerous specific details are set forth to provide a thorough understanding of the overall structure, function, manufacture, and use of the aspects as described in the disclosure, and illustrated in the accompanying drawings. Well-known operations, components, and elements have not been described in detail so as not to obscure the aspects described in the specification. The reader will understand that the aspects described, and illustrated herein are non-limiting aspects, and thus it can be appreciated that the specific structural, and functional details disclosed herein may be representative, and illustrative. Variations, and changes thereto may be made without departing from the scope of the claims. Furthermore, it is to be understood that such terms as “forward”, “rearward”, “left”, “right”, “upwardly”, “downwardly”, and the like are words of convenience, and are not to be construed as limiting terms.

In the following description, like reference characters designate like or corresponding parts throughout the several views of the drawings. Also in the following description, it is to be understood that such terms as “forward”, “rearward”, “left”, “right”, “upwardly”, “downwardly”, and the like are words of convenience, and are not to be construed as limiting terms.

Before explaining various aspects of the systems, and methods disclosed herein in detail, it should be noted that the illustrative aspects are not limited in application or use to the details of disclosed in the accompanying drawings, and description. It shall be appreciated that the illustrative aspects may be implemented or incorporated in other aspects, variations, and modifications, and may be practiced or carried out in various ways. Further, unless otherwise indicated, the terms, and expressions employed herein have been chosen for the purpose of describing the illustrative aspects for the convenience of the reader, and are not for the purpose of limitation thereof. For example, it shall be appreciated that any reference to a specific manufacturer, software suite, application, or development platform disclosed herein is merely intended to illustrate several of the many aspects of the present disclosure. This includes any, and all references to trademarks. Accordingly, it shall be appreciated that the devices, systems, and methods disclosed herein can be implemented to enhance any software update, in accordance with any intended use, and/or user preference.

As used herein, the term “server” may refer to or include one or more computing devices that are operated by or facilitate communication, and processing for multiple parties in a network environment, such as the Internet or any public or private network. Reference to “a server” or “a processor,” as used herein, may refer to a previously-recited server, and/or processor that is recited as performing a previous step or function, a different server, and/or processor, and/or a combination of servers, and/or processors.

As used herein, the term “constant” may refer to one or more SIEM functions that remain unchanged during the issuance of an alert. For example, a constant can include an Azure Sentinel Log Analytics function, amongst others. According to some non-limiting aspects, a constant can be specifically configured in accordance with an individual client's preferences and/or requirements. For example, alert rules, as described herein, can be the same for all client deployments. However, the apparatuses, systems, and methods disclosed herein can employ client-specific constants to “fine tune” how alerts are managed for each particular client. In other words, each constant can include a whitelist of specific protocols, accounts, etc. which the alert rule manages those constants differently (e.g., skips them).

As used herein, the term “platform” shall include software and/or an ecosystem of physical resources required to enable the technological benefits provided by software. For example, a platform can include either a stand-alone software product, or a software product configured to integrate with other software or physical resources within the ecosystem required for the software to provide its technological benefit. According to some non-limiting aspects, the technological benefit provided by the software is provided to the physical resources of the ecosystem or other software employed by physical resources within the ecosystem (e.g., APIs, services, etc.). According to other non-limiting aspects, a platform can include a framework of several software applications intended and designed to work together.

As used herein, the term “network” shall include an entire enterprise information technology (“IT”) system, as deployed by a tenant. For example, a network can include a group of two or more nodes (e.g., devices) connected by any physical and/or wireless connection and configured to communicate and share information with the other node or nodes. However, the term network shall not be limited to any particular nodes or any particular means of connecting those nodes. A network can include any combination of devices (e.g., servers, desktop computers, laptop computers, personal digital assistants, mobile phones, wearables, smart appliances, etc.) configured to connect to an ethernet, intranet, and/or extranet and communicate with one another via an ad hoc connection (e.g., Bluetooth®, near field communication (“NFC”), etc.), a local area connection (“LAN”), a wireless local area network (“WLAN”), and/or a virtual private network (“VPN”), regardless of each devices' physical location. A network can further include any tools, applications, and/or services deployed by devices, or otherwise utilized by an enterprise IT system, such as a firewall, an email client, document management systems, office systems, etc. In some non-limiting aspects, a “network” can include third-party devices, applications, and/or services that, although they are owned and controlled by a third party, are authorized by the tenant to access the enterprise IT system.

Security Information, and Event Management (SIEM) includes software configured to aggregate and analyze activity from many different resources across an entire information technology (IT) infrastructure. For example, SIEM can be implemented to aggregate data (e.g., logging data, event data, threat intelligence data, etc.) from multiple systems, and analyze that data to catch abnormal behavior or potential cyberattacks. For example, SIEM may collect security data from network devices, servers, domain controllers, and more. SIEM can be implemented to store, normalize, aggregate, and apply analytics to that data to discover trends, detect threats, and enable organizations to investigate any alerts. Although known SIEM tools offer impressive functionality, including the ability to monitor events, collect data, and issue security alerts across a network, such tools are typically tailored for an implementing organization, and—more specifically-a particular network architecture, which can oftentimes be complex. Additionally, existing SIEM domains are incapable of managing and correlating events across multiple customers. Accordingly, SIEM can be expensive, resource intensive, and often it may be difficult to resolve problems with SIEM data.

One example of SIEM is Azure Sentinel, a popular, cloud-based tool. However, deploying Azure Sentinel requires a high level of skill, and, at the same time, it could be very time consuming, and error prone. Each organization that needs a security solution has special needs around monitoring, and alerting, the log sources to ingest, the detection/alert rules, the response automation, reporting, etc. Although Microsoft (MSFT) is often used by security services providers (MSSP) to manage multiple clients, the complexity of the initial configuration, deployment, and ongoing maintenance of artifacts (e.g., alert rules, workbooks, playbooks, etc.), has been increasing significantly. Additionally, most cloud-based products undergo various changes driven by the manufacturer, which can simultaneously impact all customers. These changes can be break fixes or new features/enhancements.

This can result in a high cost for both the MSSP—who must hire more expensive specialists—and for the client, who often bears at least a portion of the increasing expenses. However, there is often an overlap between some of the deployment needs of varying clients. For example, many organizations may require similar firewall monitoring solutions. In such instances, asset reuse, and re-deployment (and update) may lead to major cost reduction, and simplicity of operations. Unfortunately, known SIEM tools are technologically incapable of taking advantage of such synergies. Thus, from the initial provisioning, and throughout the automation of incident responses, MSSPs are left with limited re-use opportunities to capture efficiencies across multiple clients. Accordingly, there is a need for improved devices, systems, and methods to implement and issue SIEM client updates. Such enhancements could improve the technological performance, and cost effectiveness of SIEM, including the deployment of detection rules, visualizations, investigation workbooks, and ongoing maintenance. Additionally, such enhancements can accommodate and accelerate the adoption of manufacturer driven changes and can assist in the simultaneously deployment of such changes across multiple customers.

The present disclosure contemplates such devices, systems, and methods, all of which provide many technological benefits over conventional MSSP and SIEM platforms. For example, conventional MSSP devices, systems, and methods lack the automation, artifacts, and interfaces required to seamlessly scale an MSSP platform such that SIEM services can be provided to hundreds, if not thousands, of tenant networks. Rather, conventional MSSP devices, systems, and methods require manual integration and management, meaning they are less efficient and more expensive. Moreover, conventional MSSP devices, systems, and methods require each tenant network to share the manual resources employed by the MSSP, rendering each tenant network less secure. In contrast, the devices, systems, and methods disclosed herein are highly automated and thus, configured to enable an MSSP to continuously monitor a tenant's network and clients in real-time. Not only are conventional MSSP devices, systems, and methods technologically incapable of such automation, but it would be highly impractical-if not impossible—for an MSSP to manually continuously monitor hundreds, if not thousands, of tenant networks in real-time. The devices, systems, and methods disclosed herein are also technologically configured to be adaptable. In conjunction with being highly scalable, this adaptability enables and MSSP to track changes across a high volume of tenant deployments, monitor responses to those changes, and autonomously implement them for any applicable tenant deployment that could similarly benefit from them. In other words, conventional MSSP devices, systems, and methods are inherently more prone security events and thus, technologically less secure than the devices, systems, and methods disclosed herein.

To deploy, at scale, repeatedly, and consistently, cloud-based SIEM implementations, such as Azure Sentinel implementations, for example, the present disclosure provides a simple visual integrated environment that allows simple management of client deployments, including, for example: (1) catalogue of various artifacts (alert rules, playbooks, workbooks, etc.); (2) Ability to select desired artifacts, and a one-click deploy to a target Sentinel environment at a client; (3) Ability to visualize all client deployments, what is deployed, what is out of date (e.g., alert rules have newer versions), and ability to visualize differences, and quickly deploy desires latest updates; and (4) Ability to make changes in bulk across multiple customers simultaneously. Such visual integrated environments could provide different functionalities depending on the specific SIEM implementation. For example, according to non-limiting aspects wherein the SIEM implementation is a product such as Splunk, the visual integrated environment can be used to integrate and manage various correlations, dashboards, lookups, apps, and/or technology add-ons configured to adapt ingested data into a different schema for improved analytics, amongst other Splunk features. According to non-limiting aspects wherein the SIEM implementation is a product such as Sentinel, the visual integrated environment can be used to integrate and manage various parsers, amongst other Sentinel features. It shall be appreciated that Splunk and Sentinel are provided merely for illustrative purposes and that the devices, systems, and methods disclosed herein can be implemented to work with any SIEM implementation to enhance network security more efficiently and at a larger scale.

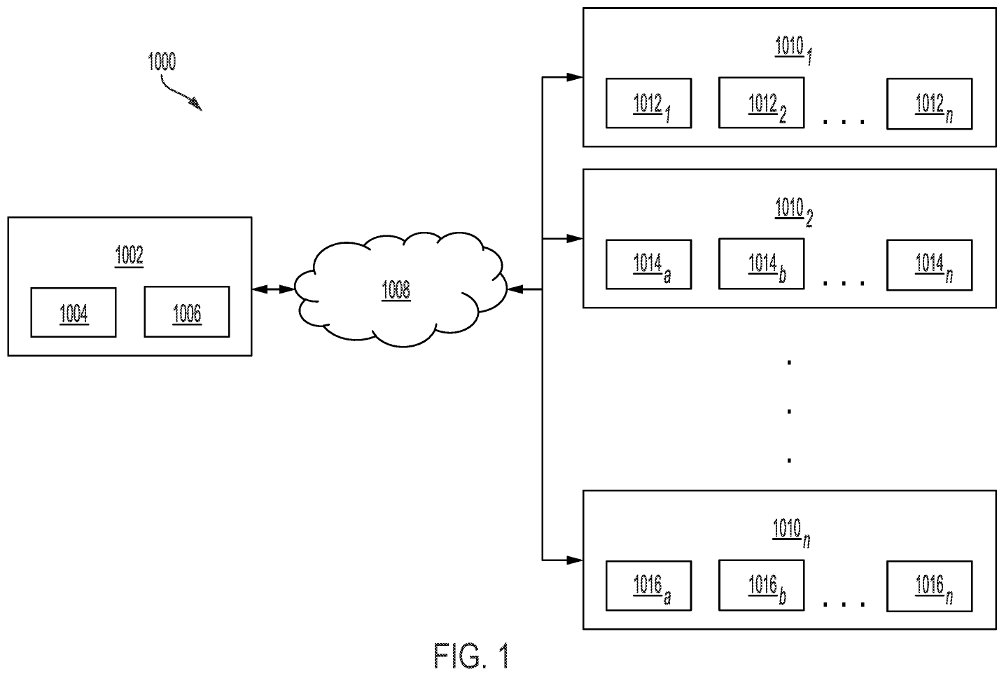

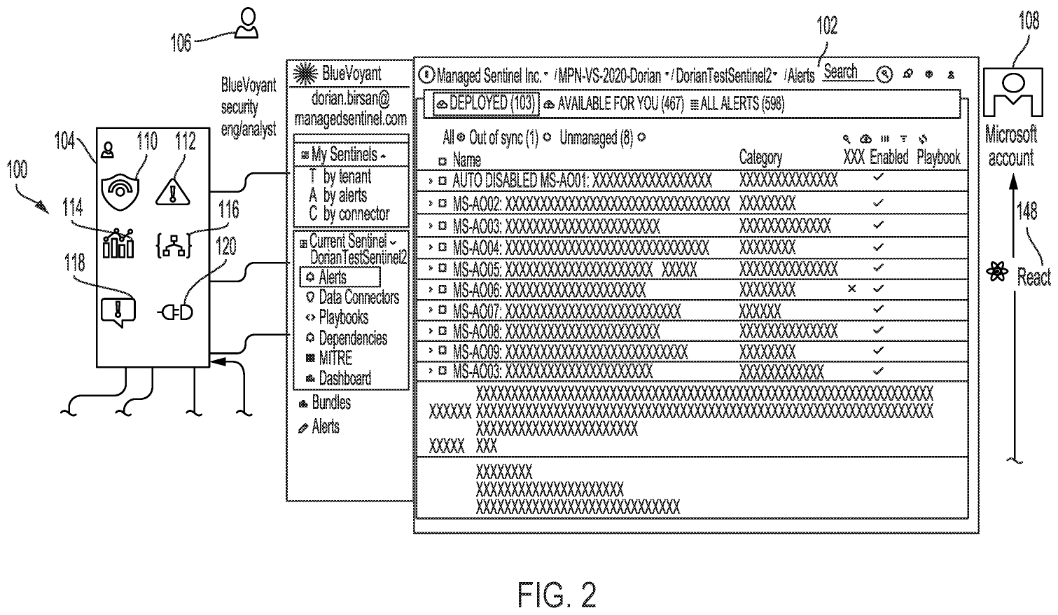

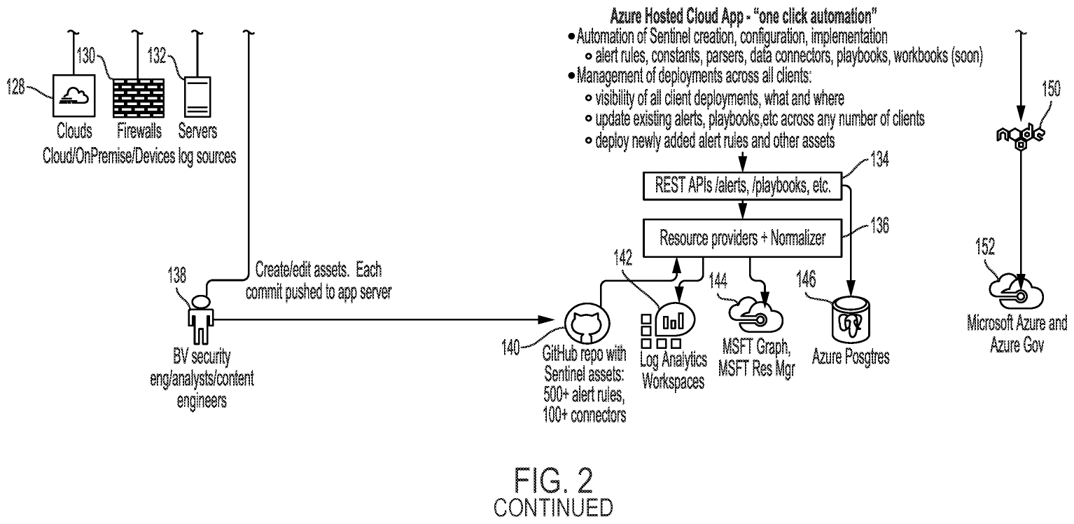

Referring now to FIG. 1, a diagram of a system 1000 configured to enhance SIEM updates, in accordance with at least one non-limiting aspect of the present disclosure. According to the non-limiting aspect of FIG. 1, the system 1000 can include a SIEM provider server 1002 comprising a memory 1006 configured to store a SIEM management application 102, and a processor 1004 configured to execute the stored SIEM management application 102, as will be discussed in further reference to FIG. 2. For example, the SIEM provider server 1002 can be a computational resource either owned or leased by the MSSP. The SIEM provider server 1002 can be communicably coupled, via network 1008, to a plurality of tenants 1010a, 1010b . . . 1010n. Each tenant 1010₁, 1010₂ . . . 1010ₙ of the plurality can represent a customer (e.g., organization) contracting with the MSSP. According to the non-limiting aspect of FIG. 1, the network 1008 can include any variety of wired, long-range wireless, and/or short-range wireless networks. For example, the network 1008 can include an internal network, a Local Area Networks (LAN), WiFi®, cellular networks, near-field communication (hereinafter “NFC”), amongst others.

In further reference to FIG. 1, each tenant 1010₁, 1010₂ . . . 1010ₙ of the plurality can host one or more instances of one or more clients 1012, 1014, 1016. For example, a first tenant 1010₁ can include one or more machines implementing one or more client applications 1012₁, 1012₂ . . . 1012ₙ, a second tenant 1010₂ can include one or more machines implementing one or more client applications 1014₁, 1014₂ . . . 1014ₙ, and/or a third tenant 1010ₙ can include one or more machines implementing one or more client applications 1016₁, 1016₂ . . . 1016ₙ. Each tenant 1010₁, 1010₂, and 1010ₙ can include an intranet by which each machine implementing the client applications. For example, each tenant 1010₁, 1010₂, and 1010 can each represent a customer, such as an organization, contracting with the MSSP for security services. Accordingly, the SIEM provider server 1002 can be configured to have oversight of each tenant 1010₁, 1010₂, and 1010ₙ of the plurality, and thus, is responsible for monitoring, and managing each client application 1012, 1014, 1016 for threats. As previously discussed, the differences, and complexity in tenant 1010₁, 1010₂, and 1010ₙ architecture can complicate this, and render it inefficient for the MSSP. Thus, known SIEM tools can leave the tenants 1010₁, 1010₂, and 1010ₙ technologically exposed, and thus, vulnerable to attacks. According to non-limiting aspects of the present disclosure, the SIEM provider server 1002 can implement a SIEM management application 102 that technologically, and practically addresses these deficiencies by enhancing the ability of the SIEM provider server 1002 to manage, and transmit alerts, and client application updates for multiple tenants based on correlated, and synergistic development needs.

Referring now to FIG. 2, a deployment diagram of the system 100 of FIG. 1, including a SIEM management application 102—or in other words, a visualization tool—is depicted in accordance with at least one non-limiting aspect of the present disclosure. According to some non-limiting aspects, the system 100 of FIG. 2 can provide a visual integrated environment that can allow the management of client deployments, including, for example: (1) a catalogue of various artifacts (e.g., alert rules, playbooks, workbooks, etc.); (2) ability to select desired artifacts, and a one-click deploy to a target Sentinel environment at a client; and (3) ability to visualize all client deployments, what is deployed, what is out of date (e.g., alert rules have newer versions), and ability to visualize differences, and quickly deploy desires latest updates.

The visual tool/system 100 is a computer security system software products, and services that combines security information management, and security event management, and provides real-time analysis of security alerts generated by applications, and network hardware. The system 100 can include SIEM management application 102 running, for example, on a SIEM provider server 1002 (FIG. 1) in communication with one or more than one client application 104, which—as previously discussed—can be hosted by one or more tenants 1010₁, 1010₂, 1010ₙ (FIG. 1). For example, according to one non-limiting aspect, the client application 104 can include a SIEM application 110 software configuration, and management to display, and/or deploy multiple alert rules, and constants 112 associated with one or more automation playbooks 116, deploy, monitor, and update workbooks 114 for dashboards, manage alert fine tuning via constants, and incidents 118. Additionally, a mechanism for detecting, visualizing differences, and updating outdated alert rules 112 across one or more than one SIEM application 110 deployments as well as SIEM implementation provided by other vendors, for example. The SIEM management application 102 may be monitored by a security engineer/analyst 106. In one aspect, the SIEM application 110 is an Azure Sentinel software application, for example, without excluding the possibility of using other SIEM applications.

The one or more than one client application 104 interfaces with various clouds 128, firewalls 130, and servers 132 through connectors 120. One or more than one security engineer/analyst/content engineer 138 interfaces with the client application 104 to create/edit assets. Each commit is pushed to an application server, such as for example, a content repository 140 (GitHub/GitLab, etc.) that contains deployable artifacts templates. Those skilled in the art will appreciate that GitHub can be used as a basic code repository, issue tracking, documentation, and wikis. Similar to GitHub, GitLab is a repository manager which lets teams collaborate on code, and may provide similar features for issue tracking, and project management as GitHub.

According to one non-limiting aspect, the content repository 140 may contain “json” files for defining alert rules, workbooks, playbooks, etc. As new content is added or updated, the changes are automatically pushed to the SIEM management application 102. In one aspect, the SIEM management application 102 may be configured as an Azure Sentinel Automation Portal (ASAP), for example. In one aspect, ASAP portal runtime software code can include server middleware that is responsible for processing the content from the content repository 140, the connections to the SIEM application 110, and other services, and services requests for the client application 104 to deploy, update, read, content from/to the SIEM application 110. In one aspect, the client application 104 provides a unified, simplified view of all client deployments, and ability to work with one or multiple clients 104 at the same time.

The SIEM management application 102 allows a security analyst 106 to not only see everything that is deployed, but to make updates to a single artifact, in a single client 104, or to multiple artifacts, across multiple clients 104, with a simple interaction.

This functionality allows an MSSP to scale to hundreds, and thousands of clients 104, with minimal staff, and minimal skills required. Content produced or updated, such as a new alert rule 112 to validate a new malware presence, can immediately be pushed to all clients 102. Additionally, in one aspect, many of these operations, including “on-content changes,” can be automated on a schedule. For example, the moment an artifact (e.g., an alert rule, a workbook, etc.) is updated in the content repository, that change can automatically triggers a webhook configured to automatically push it to all applicable tenants or clients (e.g., those tenants where the updated artifact is deployed and/or configured). Similarly, not just updated but new artifacts can also be automatically pushed (and configured) for all the tenants or clients where it is appropriate. For example, if a number of alert rules were previously configured at some tenant networks, or clients, to detect anomalous behavior in an Office 365 activity log, and a new alert rule is later created in the content repository that applies to Office 365 logs, the SIEM management application 102 can automatically deploy to all the relevant tenants or clients, because it just complements the list of detections appropriate for client's office 365 environment.

In one aspect, the SIEM management application 102 can indicate all changes, for example, what has been deployed versus what is new or updated in the content repository 140, for each client 104 SIEM application 110, assess what the changes were, and push the changes, updates or new artifacts, very quickly.

Additionally, in one aspect, the user interface (UI) commands that perform the various deployments can also be captured as scripts, checked into a client's 104 repository for validation, and automatic updates later.

In one aspect, the hosted cloud SIEM management application 102 provides “one click automation.” For example, the SIEM management application 102 provides automation of the SIEM application 110 creation, configuration, and implementation, including alert rules 112, constants, parsers, data connectors 120, playbooks 116, workbooks 114, and the like. In one aspect, the SIEM management application 102 also provides management of deployment across all clients 104. The SIEM management application 102 provides visibility of all client 104 deployments, what, and where, update existing alerts 112, playbooks 116, etc. across nay number of clients 104, and deploy newly added alert rules 112, and other assets.

The SIEM management application 102 enables 134 one click automation for REST APIs, alerts 112, playbooks 116, etc. Those skilled in the art will appreciate that a REST API, also known as RESTful API, is an application programming interface (API or web API) that conforms to the constraints of REST architectural style and allows for interaction with RESTful web services. An API (Application Programming Interface) is a set of definitions, and protocols for building, and integrating application software. The SIEM management application 102 provides real time data integration of REST APIs, alerts 112, playbooks 116, etc. to a flexible server relational cloud database 146 service, such as an Azure Postgres SQL database, for example.

The SIEM management application 102 interfaces with resource providers, and normalizer 136. The resource providers, and normalizer 136 interface with log analytics workspaces 142, Microsoft Graph, and Microsoft resource manager 144. The system 100 also includes Microsoft Azure, and Azure Government 152, a mission-critical cloud, delivers breakthrough innovation to US government customers, and their partners accessible only to US federal, state, local, and tribal governments, and their partners, with operations controlled by screened US citizens. The Microsoft Azure, and Azure Government 152 interfaces to node 150. React 148 provides interactive Uls to the account 108. Still with reference to FIG. 2, in one aspect, the SIEM management application 102 provides a quick view across all deployments, and status, plus the ability to act on them directly where a given alert is deployed, and its state.

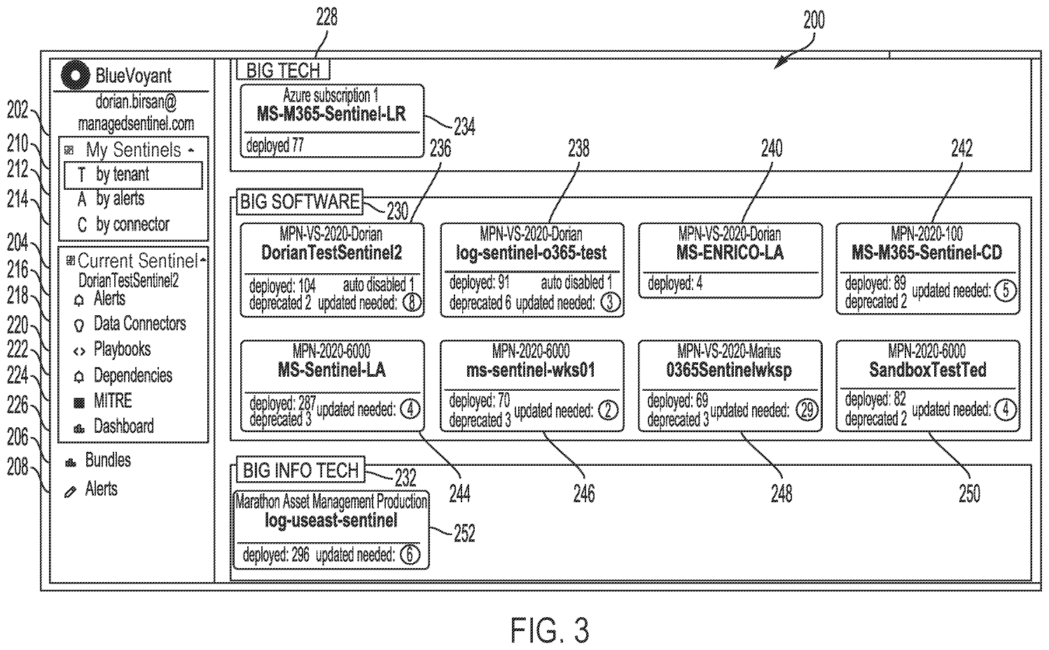

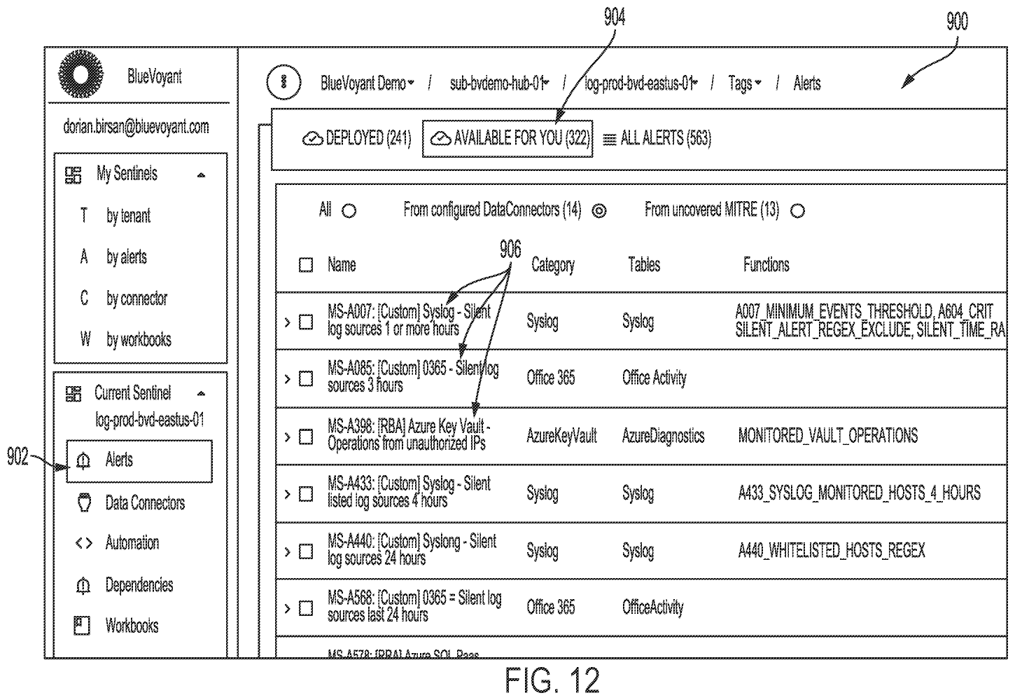

Referring now to FIG. 3, a graphical user interface 200 of the SIEM management application 102 of FIG. 2 is depicted in accordance with at least one non-limiting aspect of the present disclosure. According to the non-limiting aspect of FIG. 3, the graphical user interface 200 can be displayed when the engineer/analyst 106 selects a variety of deployment views, and status for My Sentinel 202, Current Sentinel 204, Bundles 206, and Alerts 208 from the SIEM management application 102. To display the quick view screen 200 shown in FIG. 3, the engineer/analyst 106 selects the “by tenant” button 210 from the My Sentinel 202 menu on the left side of the screen 200 to display information by tenant. Additionally, the graphical user interface 200 can provide a guided deployment. For example, the graphical user interface 200 can detect what log sources (e.g., data connectors, source types, etc.) have been configured for the SIEM implementation (e.g., Sentinel, Splunk, etc.) and can indicate a specific alert rule and/or correlation that is available to analyze the data ingested from those logs, as will be described in further detail in reference to FIG. 12.

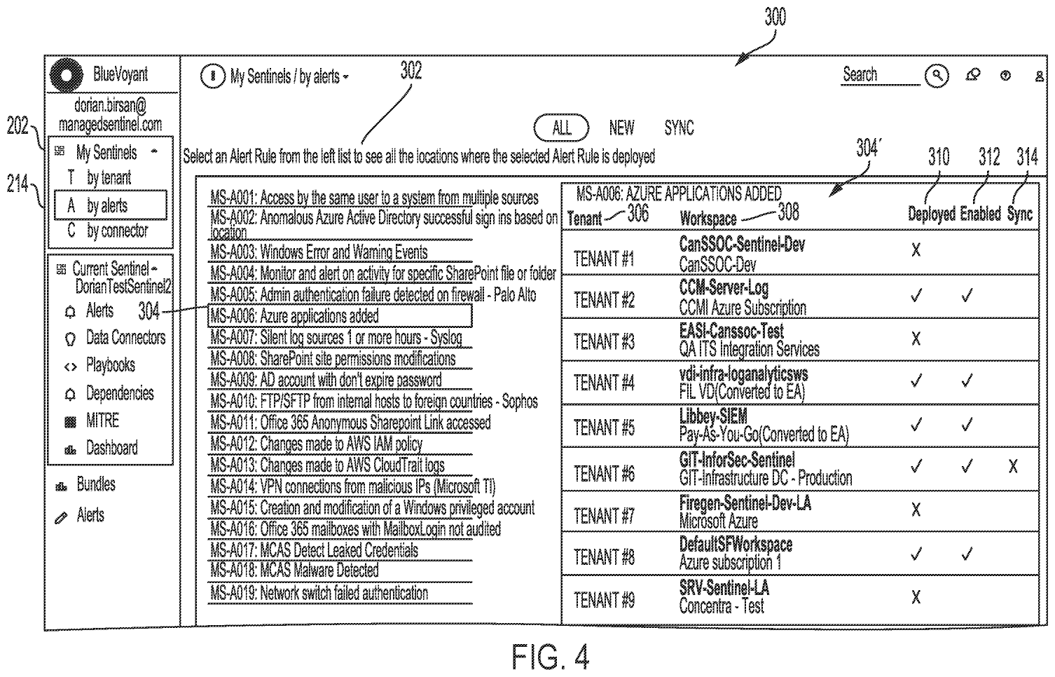

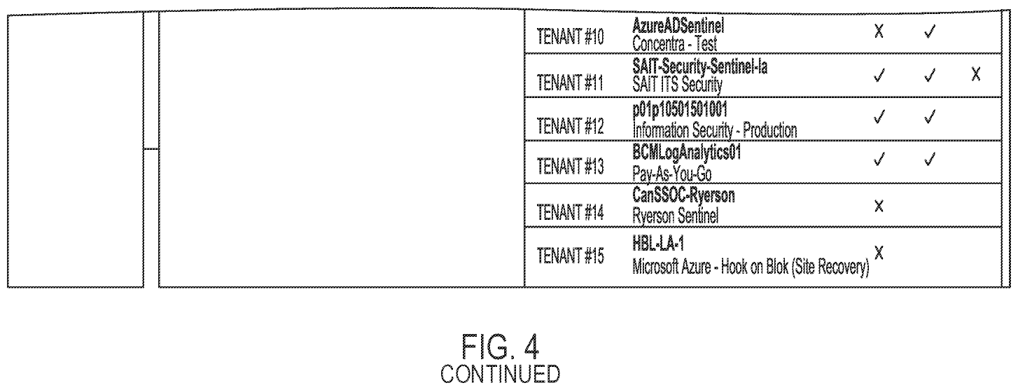

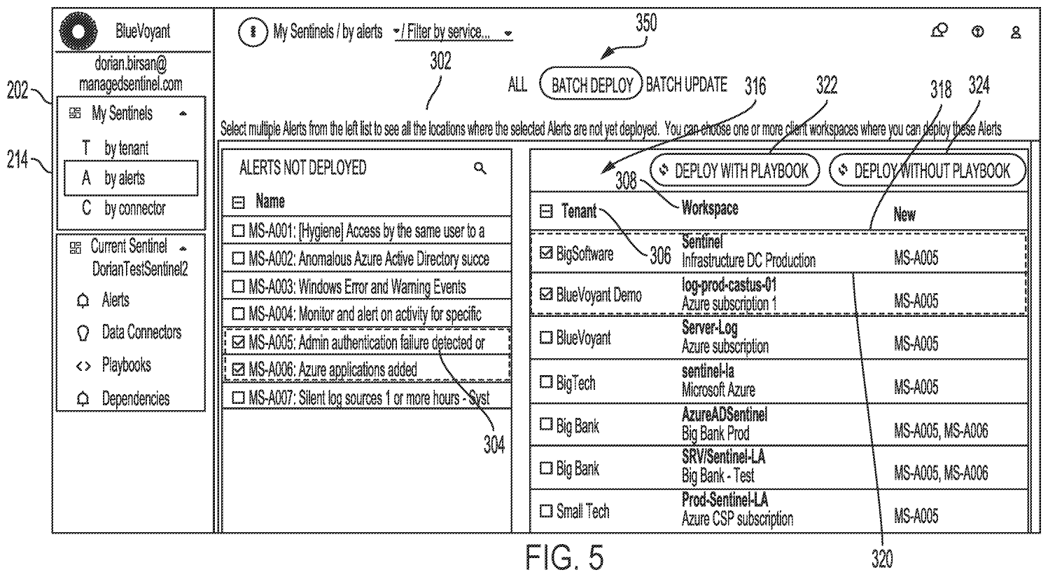

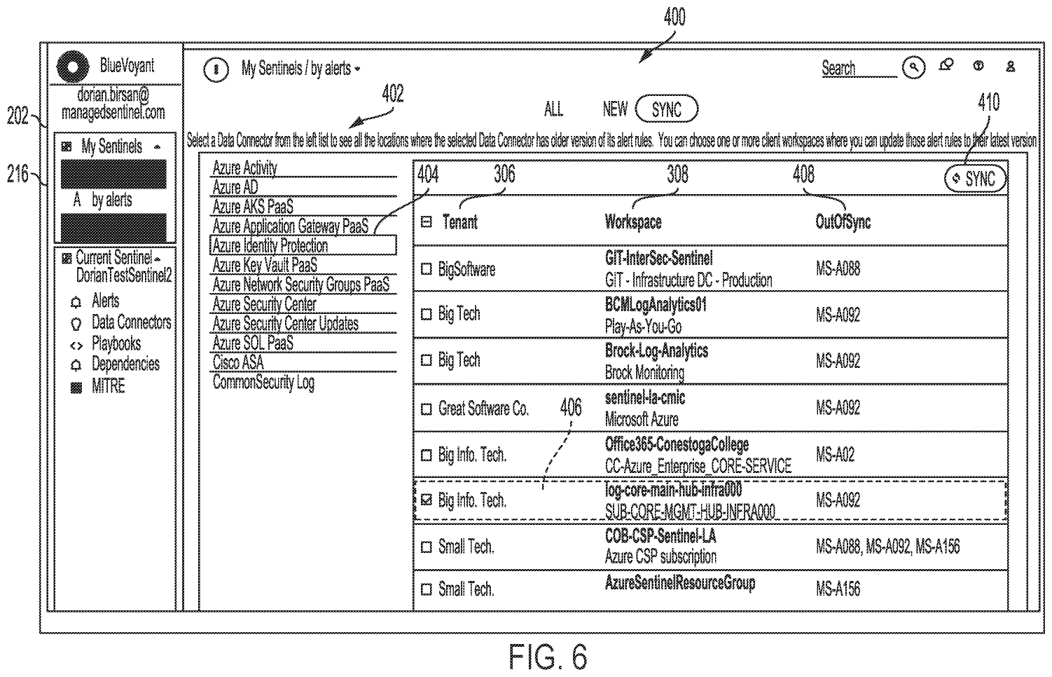

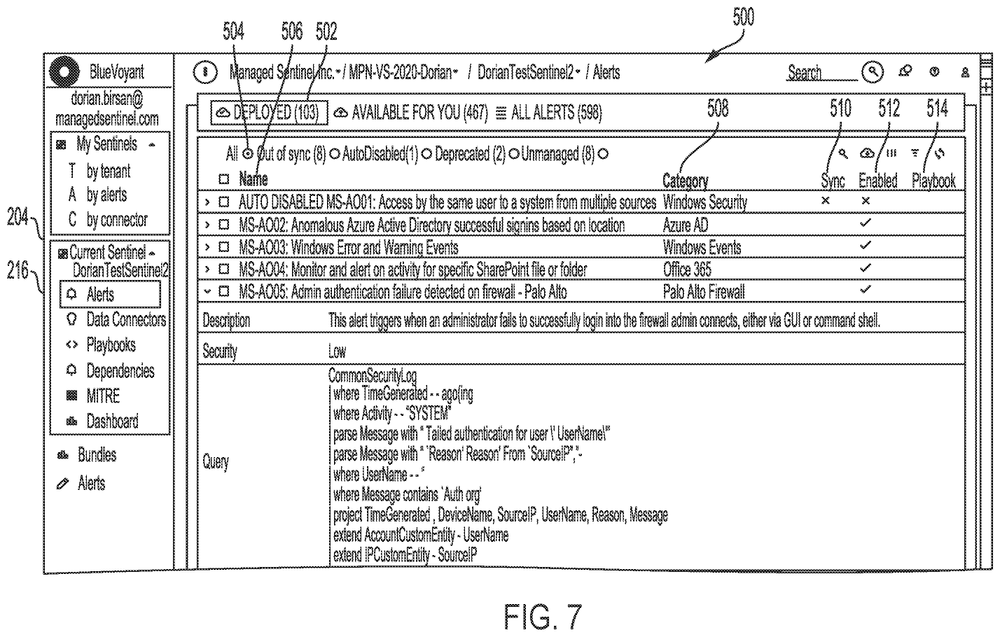

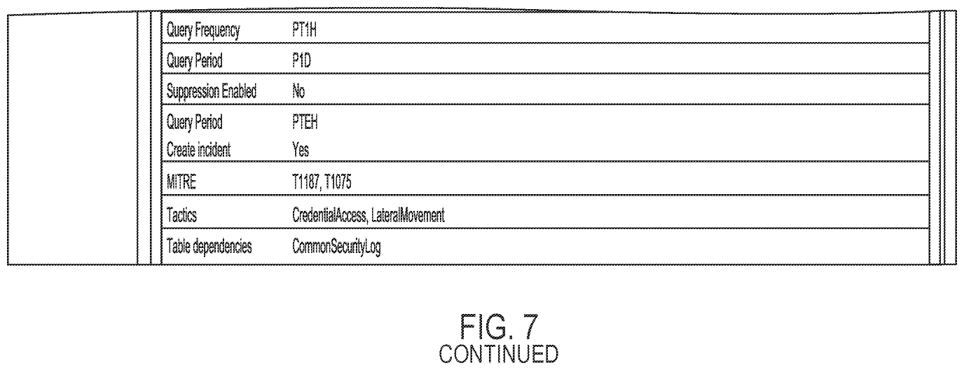

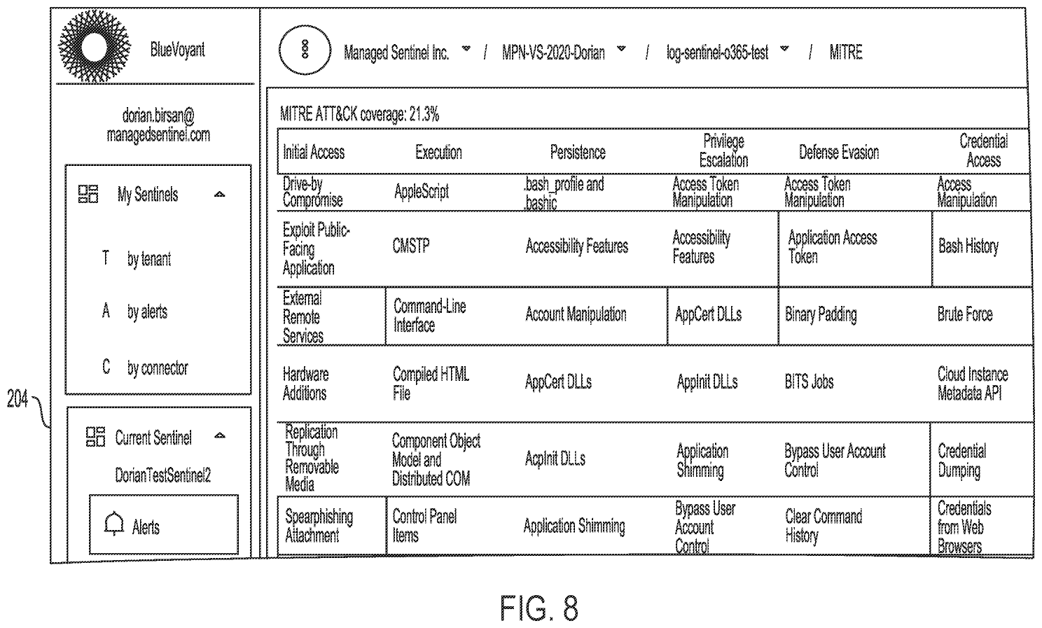

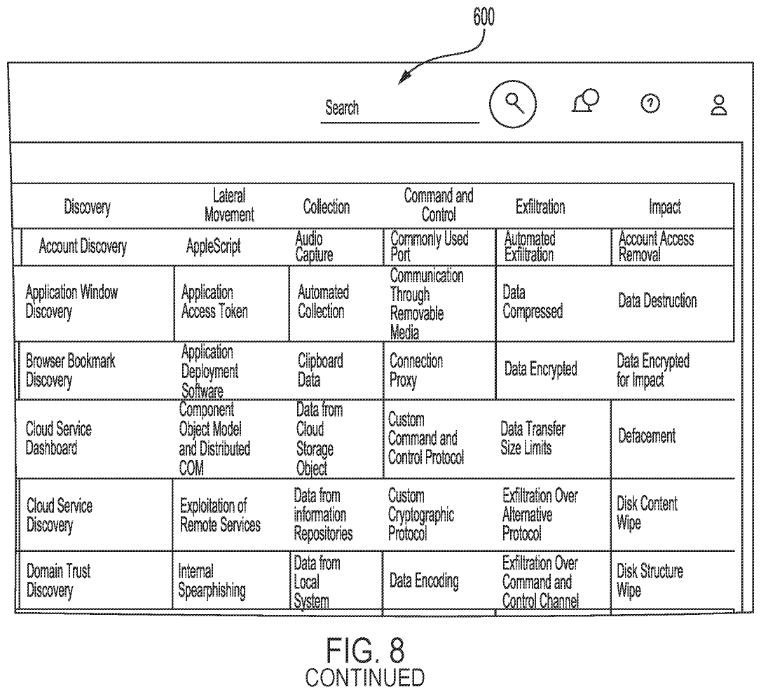

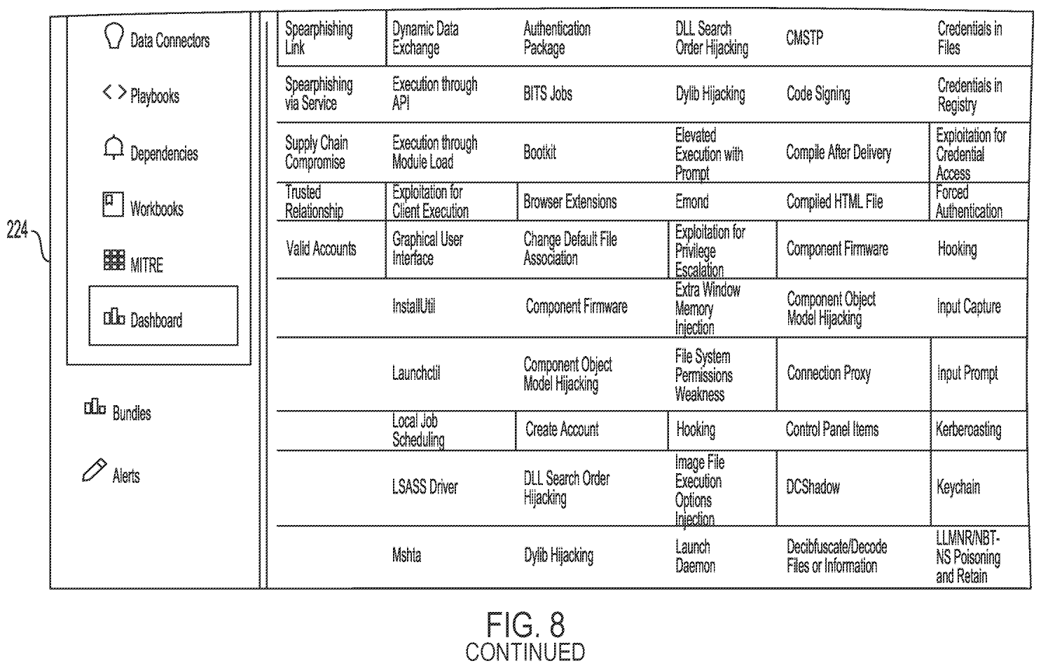

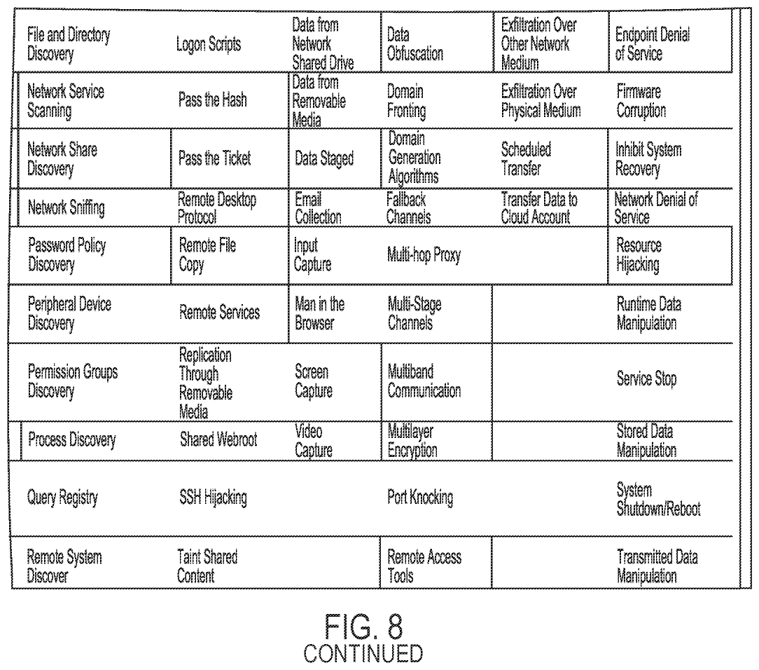

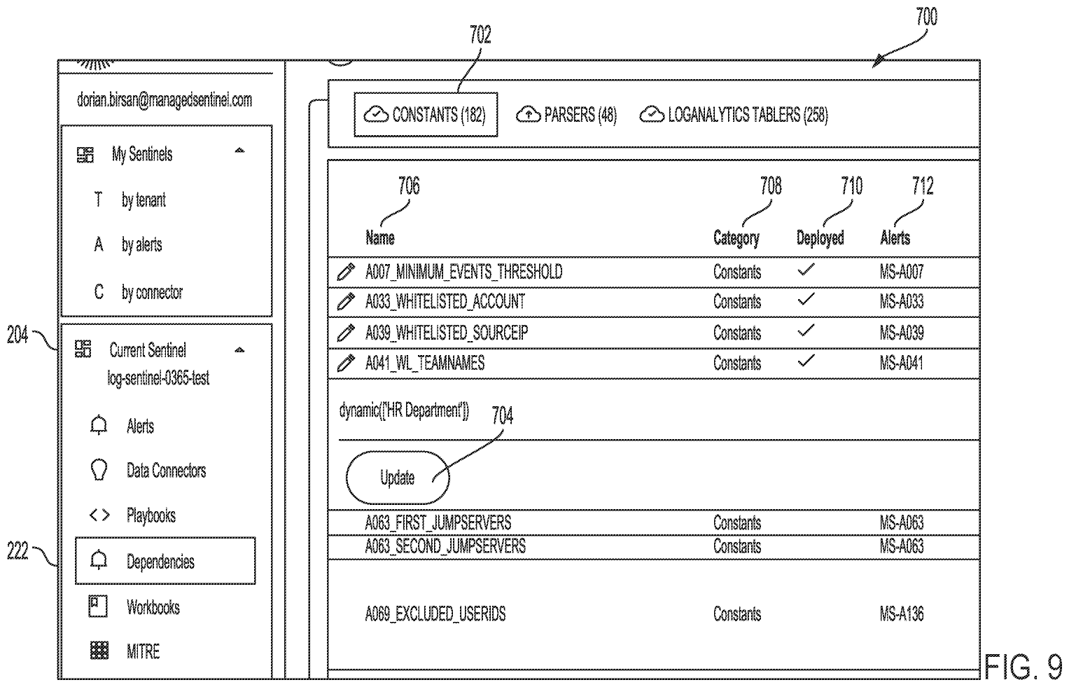

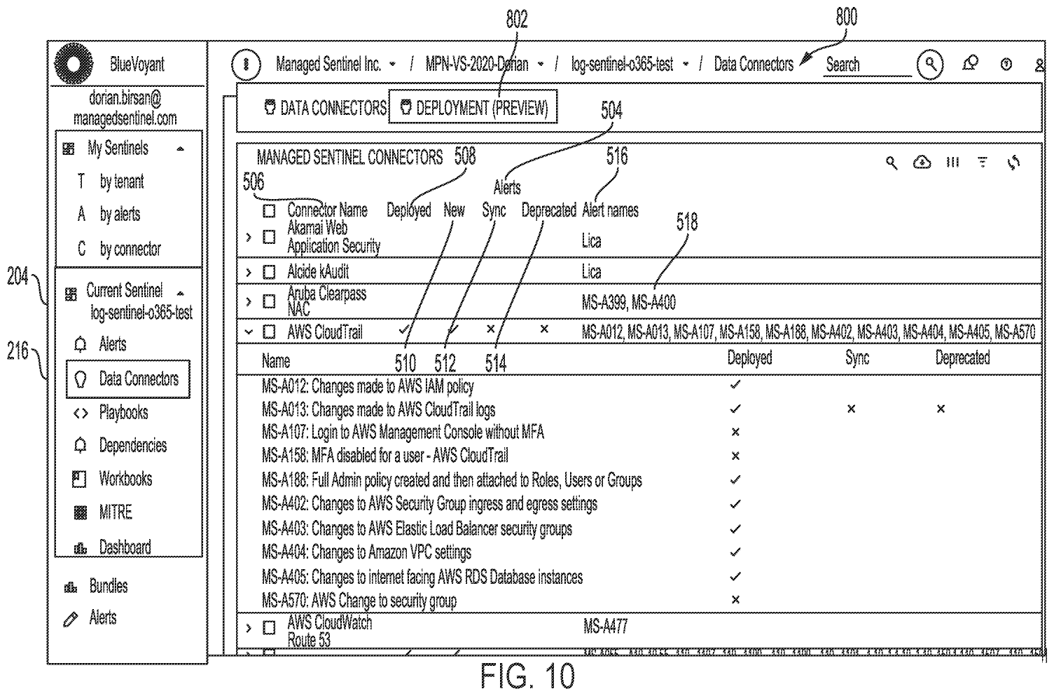

The My Sentinel 202 menu also enables other display screens by selecting the “by tenant” 210 (FIG. 3), “by alerts” 212 (FIGS. 4-5), or “by connectors” 214 (FIG. 6) buttons. With reference back to FIG. 3, from the Current Sentinel 204 menu, the engineer/analyst 106 may select deployment views, and status by Alerts 216 (FIG. 7), Data Connectors 218 (FIG. 10), Playbooks 220, Dependencies 222 (FIG. 9), MITRE 224 (FIG. 8), and Dashboard 226. Additionally, the My Sentinel 202 menu can exonerate a user of from having to locate, copy and/or paste the various identifiers (e.g., a tenant identifier, a subscription identifier, a resource group identifier, a workspace identifier, etc.) associated with a target location of the artifact deployment. The My Sentinel 202 and/or other aspects of the menu and user interface automatically ports the correct identifiers on the user's behalf.

With reference back to FIG. 3, the graphical user interface 200, or “quick view” screen, is displayed by selecting the “by tenant” button 210 from the My Sentinel 202 menu on the left side of the screen 200. The “by tenant” 210 quick view screen 200 displays information about tenants such as a first tenant 228, Big Tech, a second tenant 230, Big Software, and a third tenant 232, Big Info Tech, for example. For each of these example tenants 228, 230, 232 the quick view screen 200 displays textboxes containing information for each network coupled to the system 100 such as the number of assets deployed, deprecated, auto disabled, and in need of update. Although the present disclosure refers to a Sentinel SIEM for conciseness, and clarity of disclosure, the scope of the present disclosure is not limited in this context, and any suitable SIEM may be employed.

By way of example, for the first tenant 228, a textbox 234 indicates that the network contains 77 deployed SIEMs. For the second tenant 230, textboxes for each network 236, 238, 240, 242, 244, 246, 248, 250 indicates the number of SIEMs that are deployed, deprecated, disabled, and in need of an update. As shown, a similar textbox 252 is displayed for the third tenant 232. It will be appreciated, that the quick view 200 can be scaled to display any number of tenants, and associated textboxes to indicate the deployment, deprecation, disablement, and update status of SIEMs applications running one each client in the various networks

Referring now to FIG. 4, another graphical user interface 300 of the SIEM management application 102 of FIG. 2 is depicted in accordance with at least one non-limiting aspect of the present disclosure. According to the non-limiting aspect of FIG. 4, the graphical user interface 300 can be displayed by selecting the “by alerts” button 212 from the My Sentinel 202 menu. The screen 300 displays where a given alert is deployed, and its state. A list 302 of alert rules is displayed on the left side of the screen to the right of the menu portion. To see the location where an Alert Rule is deployed, the engineer/analyst 106 selects an Alert Rule 304 from the list 302, and a detail view 304′ of the selected Alert Rule 304 is displayed on the right side of the screen 300. The detail view 304′ displays information about a particular tenant 306, the Workspace 308, where the Alert Rule 304 is deployed 310, enabled 312, and sync 314 status.

Referring now to FIG. 5, another graphical user interface 350 of the SIEM management application 102 of FIG. 2 is depicted in accordance with at least one non-limiting aspect of the present disclosure. According to the non-limiting aspect of FIG. 5, the graphical user interface 350 can be displayed where the selected Alert Rule 304 is not yet deployed to enable the deployment of a new alert to multiple clients. One or more client workspaces 318, 320 can be selected where the selected rule Alert Rule 304 can be deployed. A new screen 316 on the right side of the screen 350 shows the selected client workspaces 318, 320 where the Alert Rule 304 is not yet deployed, and provides options for deploying the Alert Rule 304 with a playbook 322 or without a playbook 324.

Referring now to FIG. 6, another graphical user interface 400 of the SIEM management application 102 of FIG. 2 is depicted in accordance with at least one non-limiting aspect of the present disclosure. According to the non-limiting aspect of FIG. 6, the graphical user interface 400 can be displayed by selecting the “by connectors” button 214 from the My Sentinel 202 menu. The screen 400 displays a list of data connectors 402 on the left side of the screen 400. The screen 400 enables the engineer/analyst 106 to update all the alerts associated to a data connector 402 (i.e., for a log source) in one or more clients. The screen 400 also provides visibility into which alerts are outdated in each client. Accordingly, the engineer/analyst 106 can select a data Connector 404 from the left side of the screen 400 to see all the locations where the selected Data Connector 404 has an older version of its alert rules. The engineer/analyst 106 can select one or more than one client workspace 406 where an alert rule is out of sync 408, and can be updated to their latest version. The Sync button 410 is selected to update the alert rule for the selected Data Connector 404.

Referring now to FIG. 7, another graphical user interface 500 of the SIEM management application 102 of FIG. 2 is depicted in accordance with at least one non-limiting aspect of the present disclosure. According to the non-limiting aspect of FIG. 7, the graphical user interface 500 can be displayed by selecting the Alerts button 216 from the Current Sentinel 204 list. When working with a specific client (i.e., a particular Sentinel workspace), the engineer/analyst 106 can select the Deployed button 502 and the All radio button 504 to view all deployed alert rules, and expanded detail on a particular alert rule. The deployed rules, and alerts are identified by Name 506, Category 508, Sync status 510, Enabled status 512, and Playbook 514.

Referring now to FIG. 8, another graphical user interface 600 of the SIEM management application 102 of FIG. 2 is depicted in accordance with at least one non-limiting aspect of the present disclosure. According to the non-limiting aspect of FIG. 8, the graphical user interface 600 can be displayed by selecting the MITRE button 224 from the Current Sentinel 204 list. The MITRE screen 600 shows the MITRE value that maps the alert to the MITRE ATT&CK framework, and allows visibility into coverage, etc. For the example shown in FIG. 7, the MITRE ATT&CK coverage is 21.3%. In other words, the SIEM management application 102 (FIG. 2) can provide visibility help cybersecurity teams assess the effectiveness of their security operations center (SOC) processes and defensive measures to identify areas for improvement. Regarding MITRE ATT&CK, specifically, the SIEM management application 102 (FIG. 2) can assess deployed MITRE ATT&CK techniques relative to available MITRE ATT&CK techniques and provide recommendations and/or a visual indicia of notable gaps. For example, according to some non-limiting aspects, the SIEM management application 102 (FIG. 2) can employ a color coding scheme, wherein each color serves as an indicia of a gap or recommended MITRE ATT&CK technique to deploy. One such scheme is illustrated in the non-limiting aspect of FIG. 8.

Referring now to FIG. 9, another graphical user interface 700 of the SIEM management application 102 of FIG. 2 is depicted in accordance with at least one non-limiting aspect of the present disclosure. According to the non-limiting aspect of FIG. 9, the graphical user interface 700 can be displayed by selecting the Dependencies button 222 from the Current Sentinel 204 list. The screen 700 provides the ability to fine tune alert rules. An alert rule can have one or more constants, so that the alert rule can be deployed to multiple clients exactly the same, but then set various client specific values through constants (e.g., whitelists of machines, users, etc.). The constants can be displayed by selecting the Constants button 702. The constants are identified by Name 706, Category 708, Deployed status 710, and Alerts 712. The constants may be updated by selecting the Update button 704. In other words, the SIEM management application 102 (FIG. 2) can include a rules editor, which can be used to specifically tailor constants and/or rules governing the alerts issued for a particular tenant. Additionally, the SIEM management application 102 (FIG. 2) can be configured to integrate with another platform (e.g., gitlab), which can subsequently update to the SIEM management application 102 (FIG. 2)—and more specifically, the server that hosts the SIEM management application 102 (FIG. 2)—with new and/or updated rules for alerts. Thus, the SIEM management application 102 (FIG. 2) can allow for new deployments and/or sync a deployment to the latest version issued to one or more tenants.

Referring now to FIG. 10, another graphical user interface 800 of the SIEM management application 102 of FIG. 2 is depicted in accordance with at least one non-limiting aspect of the present disclosure. According to the non-limiting aspect of FIG. 10, the graphical user interface 800 can be displayed by displayed by selecting the Data Connectors 218 button from the Current Sentinel 204 list, and the Deployment (Preview) button 802. The screen 800 displays managed Sentinel connectors.

There internal model has various associations (like the MITRE techniques mentioned earlier, but also association to the log source/data connector that the alert queries search). Association with a data connector allows quick deployment of all the alerts for a given data connector, without having to select each manually. Essentially, this is a convenient semantic group construct that raises the abstraction level of configuring the SIEM, as the SIEM focuses on ingesting data through a given data connector: once a connector is configured, the alerts are deployed with one click. Also, later on, one can easily update those specific alerts or add newly added alerts developed for the data connector at a future date.

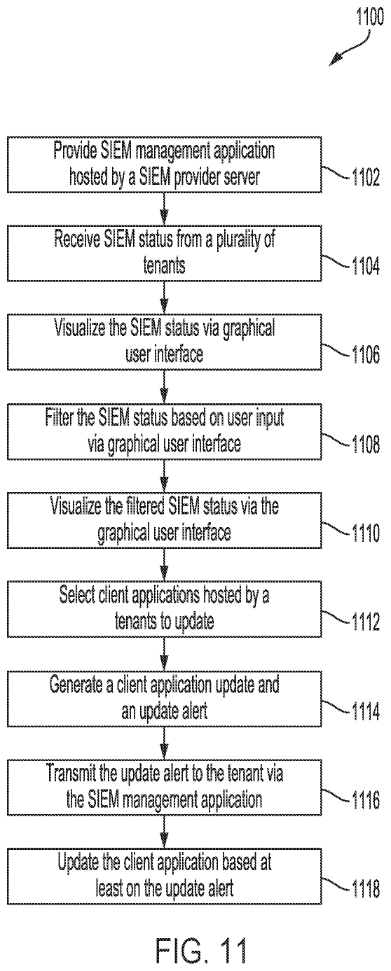

Referring now to FIG. 11, a method of using the system 1000 of FIG. 1, and the SIEM management application 102 of FIG. 2, in accordance with at least one non-limiting aspect of the present disclosure. According to the non-limiting aspect of FIG. 11, the method can enhance network security across a plurality of tenants configured to host a plurality of clients is disclosed. The method 1100 can include providing a SIEM management application configured to be hosted by a SIEM provider server, wherein the SIEM provider server is communicably coupled to the plurality of tenants 1102. The method 1100 further includes receiving, via the SIEM provider server, a SIEM status from the plurality of tenants 1104, and visualizing, via a graphical user interface of the SIEM management application, the SIEM status 1106. Additionally, the method 1100 includes filtering, via the SIEM management application, the SIEM status based, at least in part, on a user input received via the graphical user interface 1108, and then visualizing, via the graphical user interface, the filtered SIEM status 1110. Next, the method 1100 calls for selecting, via the graphical user interface, at least one client of the plurality of clients hosted by at least one tenant of the plurality of tenants to update based, at least in part, on the filtered SIEM status 1112. The method can further include generating, via the SIEM management application, a client update alert based, at least in part, on the selection 1114, and transmitting, via the SIEM management application, the client update alert to the at least one tenant 1116. Finally, the method 1100 can include updating, via the at least one tenant, the at least one client based, at least in part, on the client update alert 1118, wherein updating the at least one client enhances the network security for the at least one tenant.

Referring now to FIG. 12, another graphical user interface 900 is depicted in accordance with at least one non-limiting aspect of the present disclosure. According to the non-limiting aspect of FIG. 12, the graphical user interface 900 can provide a guided deployment for the user to simultaneously and seamlessly deploy updated and/or new artifacts 906, such as alerts or correlations, to a large number of tenants. For example, the graphical user interface 900 can detect what log sources (e.g., data connectors, source types, etc.) have been configured for a particular SIEM implementation (e.g., Sentinel, Splunk, etc.). Accordingly, a particular window 902 of the user interface 900 can list new and/or updated artifacts 906 applicable to the particular SIEM implementation, from which the user can select and deploy. A widget 904 can further indicate, at a high level, a specific number of artifacts 906 that are available to deploy. As such, a user need only check the artifacts 906 they want to push for a particular SIEM implementation, and can efficiently deploy those selected artifacts 906 to a large number of SIEM implementations.

According to still other non-limiting aspects, the system 1000 (FIG. 1) can be further configured to manage previously configured SIEMs without the use of a user interface, as the system 1000 can be configured to detect a particular SIEM implementation and/or state of the client without human intervention. This autonomy facilitates and fuels the intelligence underlying the aforementioned user interfaces, which facilitate some degree of user feedback and control. However, according to such non-limiting aspects, the system 1000 (FIG. 1) can independently apply the underlying intelligence without human intervention, applying the latest changes to artifacts, adding artifacts in the content repository, and/or updating the SIEM implementation for a large number of clients without depending on user inputs received via the aforementioned user interfaces.

Various aspects of the subject matter described herein are set out in the following numbered clauses:

Clause 1: A method for enhancing network security across a plurality of tenants configured to host a plurality of client applications, the method including: providing a Security Information, and Event Management (SIEM) management application configured to be hosted by a SIEM provider server, wherein the SIEM provider server is communicably coupled to the plurality of tenants; receiving, via the SIEM provider server, a SIEM status from the plurality of tenants; visualizing, via a graphical user interface of the SIEM management application, the SIEM status; filtering, via the SIEM management application, the SIEM status based, at least in part, on a user input received via the graphical user interface; visualizing, via the graphical user interface, the filtered SIEM status; selecting, via the graphical user interface, at least one client application of the plurality of clients applications hosted by at least one tenant of the plurality of tenants to update based, at least in part, on the filtered SIEM status; generating, via the SIEM management application, a client application update, and an update alert based, at least in part, on the selection; transmitting, via the SIEM management application, the update alert to the at least one tenant; and updating, via the at least one tenant, the at least one client application based, at least in part, on the update alert, wherein updating the at least one client application enhances the network security for the at least one tenant.

According to other non-limiting aspects, the management of previously configured SIEMs without the UI, as the system already knows the state of the client, and can apply the latest changes added to artifacts in the content repository.

Clause 2: The method according to clause 1, wherein the SIEM status includes at least one of a tenant name, a client name, and a client application version for each tenant of the plurality of tenants, or combinations thereof.

Clause 3: The method according to clauses 1 or 2, wherein the user input includes at least one of the tenant name, the client name, and the client application version for each tenant of the plurality of tenants, or combinations thereof.

Clause 4: The method according to any of clauses 1-3, wherein selecting the at least one client application is further based on a second user input received via the graphical user interface, and wherein the second user input includes at least one of a tenant name associated with the at least one client application, a client name associated with the at least one client application, and a client application version associated with the at least one client application, or combinations thereof.

Clause 5: The method according to any of clauses 1-4, wherein the SIEM provider server includes a memory configured to store a plurality of rules associated with a deployment need for each tenant of the plurality of tenants, and wherein generating the update alert is based, at least in part, on at least one rule of the plurality of rules that is associated with the at least one tenant.

Clause 6: The method according to any of clauses 1-5, further including correlating, via the SIEM management application, the plurality of rules into a plurality of playbooks based, at least in part, on the deployment need for each tenant of the plurality of tenants.

Clause 7: The method according to any of clauses 1-6, wherein the graphical user interface includes a playbook widget, wherein selecting the at least one client application is further based on a user interaction with the playbook widget via the graphical user interface, and wherein generating the update alert is based, at least in part, on at least one playbook of the plurality of playbooks that is associated with the at least one tenant.

Clause 8: The method according to any of clauses 1-7, wherein a deployment need for the at least one tenant includes a firewall monitoring protocol.

Clause 9: The system according to any of clauses 1-8, further including storing the generated client application update in the memory, wherein updating the at least one client application further includes retrieving, via the at least one tenant, the generated client application update from the memory.

Clause 10: The system according to any of clauses 1-9, wherein the memory is further configured to store an artifact template, and wherein generating the update alert is further based on the stored artifact template.

Clause 11: The method according to any of clauses 1-10, wherein the stored artifact template includes a writable js on file.

Clause 12: The method according to any of clauses 1-11, further including: generating a new template including at least one of a new rule, a new workbook, and a new playbook, or combinations thereof, based on the SIEM status; and storing the new template in the memory.

Clause 13: The method according to clauses 1-12, wherein the SIEM status includes a number of deployed client applications, a number of deprecated client applications, and a number disabled client applications for each tenant of the plurality of tenants, or combinations thereof.

Clause 14: The system according to clauses 1-13, wherein the plurality of tenants are remotely located relative to the SIEM provider server.

Clause 15: A system for enhancing network security, the system including: a plurality of tenants configured to host a plurality of clients; and a Security Information, and Event Management (SIEM) provider server communicably coupled to the plurality of tenants, wherein the SIEM provider server includes a processor, and a memory, wherein the memory is configured to store a SIEM management application that, when executed by the processor, causes the processor to: receive a SIEM status from the plurality of tenants; visualize the SIEM status via a graphical user interface of the SIEM management application illustrated on a display communicably coupled to the SIEM provider server; filter the SIEM status based, at least in part, on a user input received via the graphical user interface; visualize the filtered SIEM status via the graphical user interface; determine at least one client of the plurality of clients hosted by at least one tenant of the plurality of tenants to update based, at least in part, on the filtered SIEM status; generate an update alert based, at least in part, on the determination; transmit the update alert to the at least one tenant; and update the at least one client application based, at least in part, on the update alert, wherein updating the at least one client enhances the network security for the at least one tenant.

Clause 16: The system according to clause 15, wherein the memory is further configured to store a plurality of rules associated with a deployment need for each tenant of the plurality of tenants, and wherein, when executed by the processor, the SIEM management application further causes the processor to generate the update alert based, at least in part, on at least one rule of the plurality of rules that is associated with the at least one tenant.

Clause 17: The system according to clauses 15 or 16, wherein, when executed by the processor, the SIEM management application further causes the processor to correlate the plurality of rules into a plurality of playbooks based, at least in part, on the deployment need for each tenant of the plurality of tenants.

Clause 18: The system according to any of clauses 15-17, wherein the graphical user interface includes a playbook widget, wherein the determination of the at least one client is further based on a user interaction with the playbook widget via the graphical user interface, and wherein the generation of the update alert is based, at least in part, on at least one playbook of the plurality of playbooks that is associated with the at least one tenant.

Clause 19: The system according to any of clauses 15-18, further including generating a prediction associated with a future behavior of the nuclear reactor based, at least in part, on the determined condition of the reactor vessel internals and the diagnostic conclusion associated with the nuclear reactor.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes, and/or devices described herein, or a microprocessor configured by a computer program which at least partially carries out processes, and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer readable storage medium. Firmware may be embodied as code, instructions or instruction sets, and/or data that are hard-coded (e.g., nonvolatile) in memory devices.

As used in any aspect herein, the terms “component,” “system,” “module”, and the like can refer to a computer-related entity, either hardware, a combination of hardware, and software, software, or software in execution.

As used in any aspect herein, an “algorithm” refers to a self-consistent sequence of steps leading to a desired result, where a “step” refers to a manipulation of physical quantities, and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms may be associated with the appropriate physical quantities, and are merely convenient labels applied to these quantities, and/or states.

1. A method for simultaneously monitoring and enhancing network security across a plurality of tenants configured to host a plurality of client applications, the method comprising:
providing a Security Information, and Event Management (SIEM) management application configured to be hosted by a SIEM provider server, wherein the SIEM provider server is communicably coupled to the plurality of tenants;
receiving, via the SIEM provider server, a SIEM status from the plurality of tenants;
visualizing, via a graphical user interface of the SIEM management application, the SIEM status;
filtering, via the SIEM management application, the SIEM status based, at least in part, on a user input received via the graphical user interface;
visualizing, via the graphical user interface, the filtered SIEM status;
selecting, via the graphical user interface, at least one client application of the plurality of clients applications hosted by a subset of the plurality of tenants to update based, at least in part, on the filtered SIEM status;
generating, via the SIEM management application, a client application update, and an update alert based, at least in part, on the selection;
transmitting, via the SIEM management application, the update alert to the subset of the plurality of tenants; and
updating, via the subset of the plurality of tenants, the at least one client application based, at least in part, on the update alert, wherein updating the at least one client application enhances the network security for the subset of the plurality of tenants.

2. The method of claim 1, wherein the SIEM status comprises at least one of a tenant name, a client name, and a client application version for each tenant of the plurality of tenants, or combinations thereof.

3. The method of claim 2, wherein the user input comprises at least one of the tenant name, the client name, and the client application version for each tenant of the plurality of tenants, or combinations thereof.

4. The method of claim 2, wherein selecting the at least one client application is further based on a second user input received via the graphical user interface, and wherein the second user input comprises at least one of a tenant name associated with the at least one client application, a client name associated with the at least one client application, and a client application version associated with the at least one client application, or combinations thereof.

5. The method of claim 1, wherein the SIEM provider server comprises a memory configured to store a plurality of rules associated with a deployment need for each tenant of the plurality of tenants, and wherein generating the update alert is based, at least in part, on at least one rule of the plurality of rules that is associated with the subset of the plurality of tenants.

6. The method of claim 5, further comprising correlating, via the SIEM management application, the plurality of rules into a plurality of playbooks based, at least in part, on the deployment need for each tenant of the plurality of tenants.

7. The method of claim 6, wherein the graphical user interface comprises a playbook widget, wherein selecting the at least one client application is further based on a user interaction with the playbook widget via the graphical user interface, and wherein generating the update alert is based, at least in part, on at least one playbook of the plurality of playbooks that is associated with the subset of the plurality of tenants.

8. The method of claim 6, wherein a deployment need for the subset of the plurality of tenants comprises a firewall monitoring protocol.

9. The method of claim 5, further comprising storing the generated client application update in the memory, wherein updating the at least one client application further comprises retrieving, via the subset of the plurality of tenants, the generated client application update from the memory.

10. The method of claim 5, wherein the memory is further configured to store an artifact template, and wherein generating the update alert is further based on the stored artifact template.

11. The method of claim 10, wherein the stored artifact template comprises a writable json file.

12. The method of claim 10, further comprising:
generating a new template comprising at least one of a new rule, a new workbook, and a new playbook, or combinations thereof, based on the SIEM status; and
storing the new template in the memory.

13. The method of claim 1, wherein the SIEM status comprises a number of deployed client applications, a number of deprecated client applications, and a number disabled client applications for each tenant of the plurality of tenants, or combinations thereof.

14. The method of claim 1, wherein the plurality of tenants are remotely located relative to the SIEM provider server.

15. A system for enhancing network security, the system comprising:
a plurality of tenants configured to host a plurality of clients; and
a Security Information, and Event Management (SIEM) provider server communicably coupled to the plurality of tenants, wherein the SIEM provider server comprises a processor, and a memory, wherein the memory is configured to store a SIEM management application that, when executed by the processor, causes the processor to:
continuously and simultaneously receive a SIEM status from the plurality of tenants;
visualize the SIEM status via a graphical user interface of the SIEM management application illustrated on a display communicably coupled to the SIEM provider server;
filter the SIEM status based, at least in part, on a user input received via the graphical user interface;
visualize the filtered SIEM status via the graphical user interface;
determine at least one client of the plurality of clients hosted by a subset of the plurality of tenants of the plurality of tenants to update based, at least in part, on the filtered SIEM status;
generate an update alert based, at least in part, on the determination;
transmit the update alert to the subset of the plurality of tenants; and
update the at least one client based, at least in part, on the update alert, wherein updating the at least one client enhances the network security for the subset of the plurality of tenants.

16. The system of claim 15, wherein the memory is further configured to store a plurality of rules associated with a deployment need for each tenant of the plurality of tenants, and wherein, when executed by the processor, the SIEM management application further causes the processor to generate the update alert based, at least in part, on at least one rule of the plurality of rules that is associated with the subset of the plurality of tenants.

17. The system of claim 16, wherein, when executed by the processor, the SIEM management application further causes the processor to correlate the plurality of rules into a plurality of playbooks based, at least in part, on the deployment need for each tenant of the plurality of tenants.

18. The system of claim 17, wherein the graphical user interface comprises a playbook widget, wherein the determination of the at least one client is further based on a user interaction with the playbook widget via the graphical user interface, and wherein the generation of the update alert is based, at least in part, on at least one playbook of the plurality of playbooks that is associated with the subset of the plurality of tenants.
